(19) United States
(12) Patent Application Publication
(10) Pub. No.: US 2016/0231461 A1
(43) Pub. Date: Aug. 11, 2016

(54) NUCLEAR MAGNETIC RESONANCE (NMR) POROSITY INTEGRATION IN A PROBABILISTIC MULTI-LOG INTERPRETATION METHODOLOGY

(71) Applicant: Halliburton Energy Services, Inc., Houston, TX (US)

(72) Inventors: James E. GALFORD, Missouri City, TX (US); Ronnel C. BALLIET, Houston, TX (US)

(73) Assignee: HALLIBURTON ENERGY SERVICES, INC., Houston, TX (US)

(21) Appl. No.: 14/398,250

(22) PCT Filed: Dec. 19, 2013
(86) PCT No.: PCT/US2013/076674

§ 371 Date: Oct. 31, 2014

(51) Int. Cl. G01V 11/00; G01V 3/32

(52) U.S. Cl. CPC G01V 11/00; G01V 3/32

(57) ABSTRACT

Theoretical response equations, representing measurements obtained from multiple logging modalities, can be combined into a model that includes a system of simultaneous equations involving the formation volumes of an unknown subterranean region. This developed model can be used to probabilistically estimate volume information regarding an unknown subterranean formation, based on an input data set of measurements of the unknown subterranean region.

### TECHNICAL FIELD

This invention relates to modeling subterranean formation properties based on measurement data obtained using a variety of subterranean logging modalities.

### BACKGROUND

In the field of logging (e.g., wireline logging, logging while drilling (LWD) and measurement while drilling (MWD)), a variety of subterranean logging tools have been used to explore the subsurface. These tools can employ various logging modalities (e.g., nuclear resonance, density logging, neutron logging, acoustic logging, and so forth), and can be used to measure various properties of a subterranean region.

### DESCRIPTION OF DRAWINGS

FIG. 1A is a diagram of an example well system.

FIG. 1B is a diagram of an example well system that includes an NMR logging tool in a wireline logging environment.

FIG. 1C is a diagram of an example well system that includes an NMR logging tool in a logging while drilling (LWD) environment.

FIG. 2 is a diagram of an example process for modeling the volume of fluids and minerals of a subterranean region.

FIG. 3 is a diagram of an example volumetric representation of an example subterranean region.

FIGS. 4A-B show plots for example of formation mineral and fluid volume results obtained by using several example logs in combination with a NMR total porosity log.

FIG. 5 shows a diagram of an example computer system.

### DETAILED DESCRIPTION

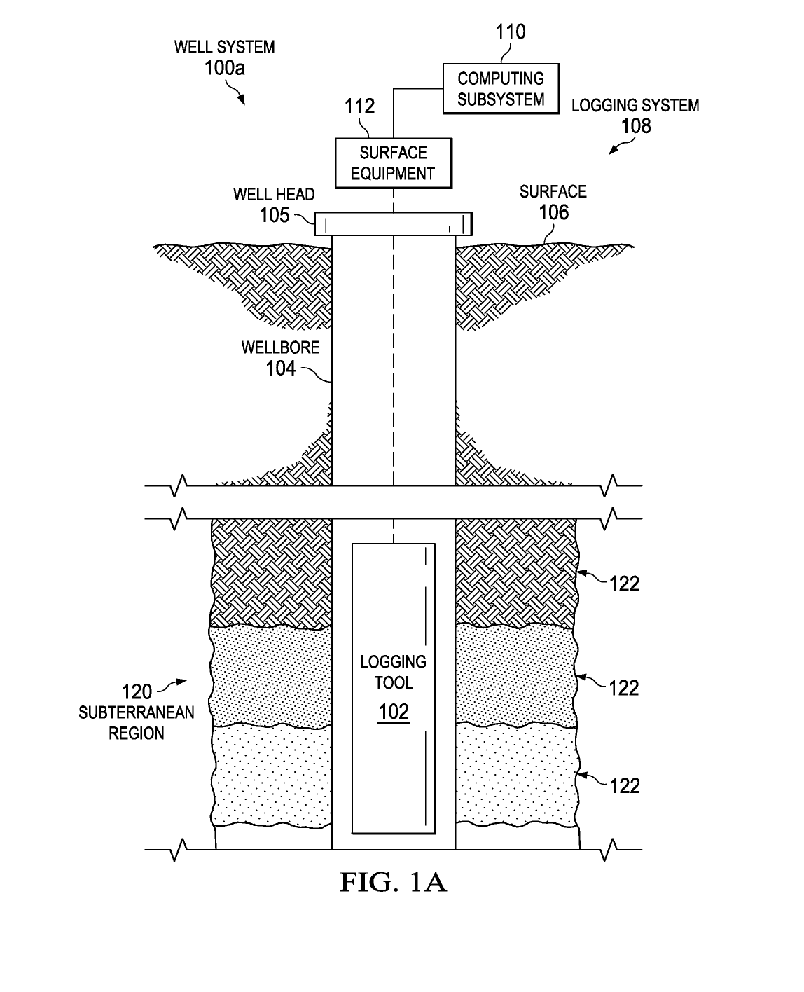

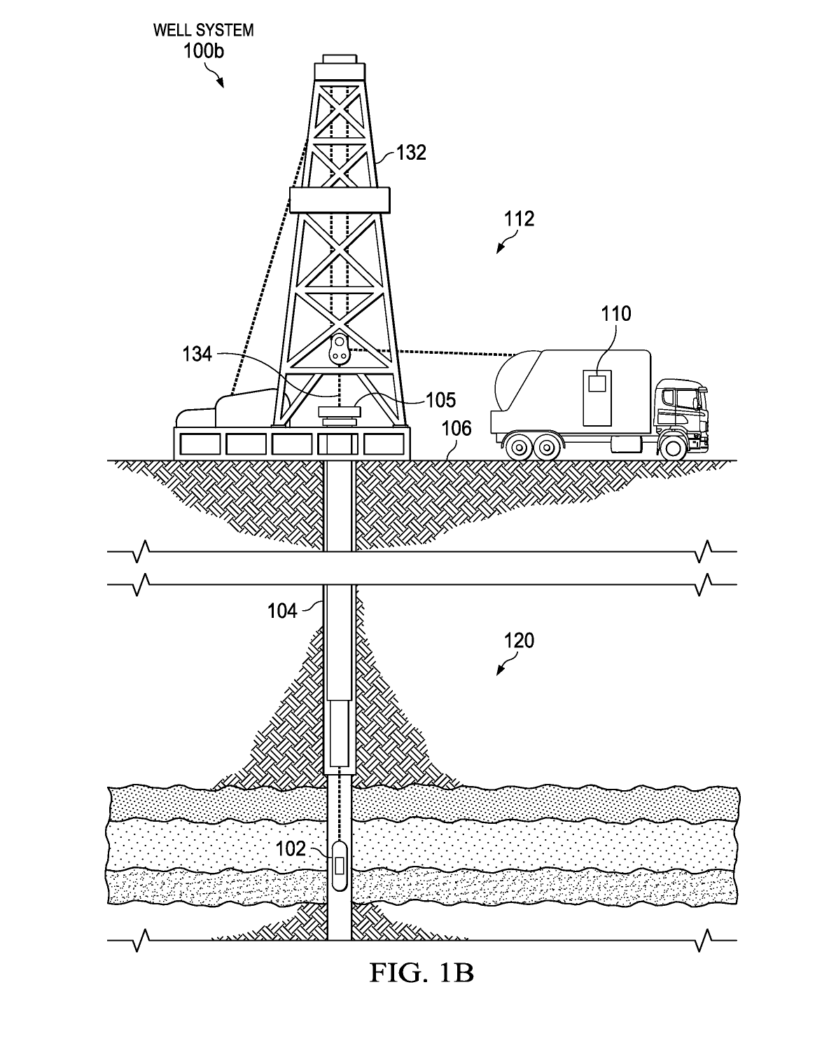

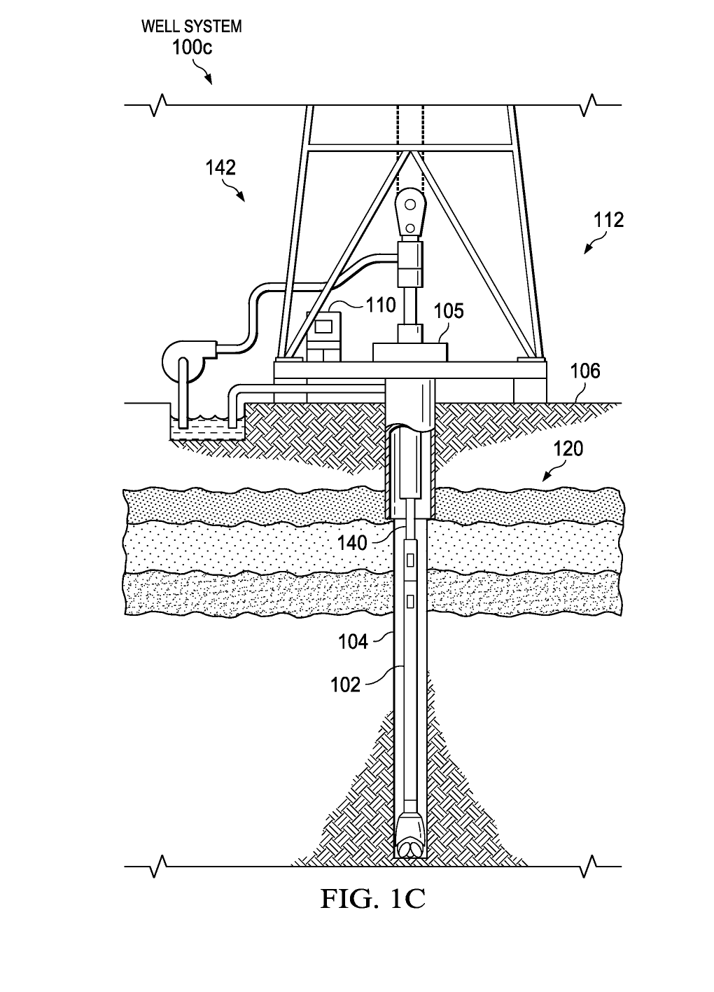

FIG. 1A is a diagram of an example well system 100a. The example well system 100a includes a logging system 108 and a subterranean region 120 beneath the ground surface 106. A well system can include additional or different features that are not shown in FIG. 1A. For example, the well system 100a may include additional drilling system components, wireline logging system components, etc.

The subterranean region 120 can include all or part of one or more subterranean formations or zones. The example subterranean region 120 shown in FIG. 1A includes multiple subsurface layers 122 and a wellbore 104 penetrated through the subsurface layers 122. The subsurface layers 122 can include sedimentary layers, rock layers, sand layers, or combinations of these other types of subsurface layers. One or more of the subsurface layers can contain fluids, such as brine, oil, gas, etc. Although the example wellbore 104 shown in FIG. 1A is a vertical wellbore, the logging system 108 can be implemented in other wellbore orientations. For example, the logging system 108 may be adapted for horizontal wellbores, slant wellbores, curved wellbores, vertical wellbores, or combinations of these.

The example logging system 108 includes a logging tool 102, surface equipment 112, and a computing subsystem 110. In the example shown in FIG. 1A, the logging tool 102 is a downhole logging tool that operates while disposed in the wellbore 104. The example surface equipment 112 shown in FIG. 1A operates at or above the surface 106, for example, near the well head 105, to control the logging tool 102 and possibly other downhole equipment or other components of the well system 100. The example computing subsystem 110 can receive and analyze logging data from the logging tool 102. A logging system can include additional or different features, and the features of a logging system can be arranged and operated as represented in FIG. 1A or in another manner.

In some instances, all or part of the computing subsystem 110 can be implemented as a component of, or can be integrated with one or more components of, the surface equipment 112, the logging tool 102 or both. In some cases, the computing subsystem 110 can be implemented as one or more discrete computing system structures separate from the surface equipment 112 and the logging tool 102.

In some implementations, the computing subsystem 110 is embedded in the logging tool 102, and the computing subsystem 110 and the logging tool 102 can operate concurrently while disposed in the wellbore 104. For example, although the computing subsystem 110 is shown above the surface 106 in the example shown in, all or part of the computing subsystem 110 may reside below the surface 106, for example, at or near the location of the logging tool 102.

The well system 100a can include communication or telemetry equipment that allow communication among the computing subsystem 110, the logging tool 102, and other components of the logging system 108. For example, the components of the logging system 108 can each include one or more transceivers or similar apparatus for wired or wireless data communication among the various components. For example, the logging system 108 can include systems and apparatus for wireline telemetry, wired pipe telemetry, mud pulse telemetry, acoustic telemetry, electromagnetic telemetry, or a combination of these other types of telemetry. In some cases, the logging tool 102 receives commands, status signals, or other types of information from the computing subsystem 110 or another source. In some cases, the computing subsystem 110 receives logging data, status signals, or other types of information from the logging tool 102 or another source.

Logging operations can be performed in connection with various types of downhole operations at various stages in the lifetime of a well system. Structural attributes and components of the surface equipment 112 and logging tool 102 can be adapted for various types of logging operations. For example, logging may be performed during drilling operations, during wireline logging operations, or in other contexts. As such, the surface equipment 112 and the logging tool 102 may include, or may operate in connection with drilling equipment, wireline logging equipment, or other equipment for other types of operations.

In some examples, logging operations are performed during wireline logging operations. FIG. 1B shows an example well system 100b that includes the logging tool 102 in a wireline logging environment. In some example wireline logging operations, a the surface equipment 112 includes a platform above the surface 106 is equipped with a derrick 132 that supports a wireline cable 134 that extends into the wellbore 104. Wireline logging operations can be performed, for example, after a drilling string is removed from the wellbore 104, to allow the wireline logging tool 102 to be lowered by wireline or logging cable into the wellbore 104.

In some examples, logging operations are performed during drilling operations. FIG. 1C shows an example well system 100c that includes the logging tool 102 in a logging while drilling (LWD) environment. Drilling is commonly carried out using a string of drill pipes connected together to form a drill string 140 that is lowered through a rotary table into the wellbore 104. In some cases, a drilling rig 142 at the surface 106 supports the drill string 140, as the drill string 140 is operated to drill a wellbore penetrating the subterranean region 120. The drill string 140 may include, for example, a kelly, drill pipe, a bottom hole assembly, and other components. The bottom hole assembly on the drill string may include drill collars, drill bits, the logging tool 102, and other components. The logging tools may include measuring while drilling (MWD) tools, LWD tools, and others.

In some example implementations, the logging tool 102 includes a tool for obtaining measurements from the subterranean region 120. As shown, for example, in FIG. 1B, the logging tool 102 can be suspended in the wellbore 104 by a coiled tubing, wireline cable, or another structure that connects the tool to a surface control unit or other components of the surface equipment 112. In some example implementations, the logging tool 102 is lowered to the bottom of a region of interest and subsequently pulled upward (e.g., at a substantially constant speed) through the region of interest. As shown, for example, in FIG. 1C, the logging tool 102 can be deployed in the wellbore 104 on jointed drill pipe, hard wired drill pipe, or other deployment hardware. In some example implementations, the logging tool 102 collects data during drilling operations as it moves downward through the region of interest during drilling operations. In some example implementations, the logging tool 102 collects data while the drilling string 140 is moving, for example, while it is being tripped in or tripped out of the wellbore 104.

In some example implementations, the logging tool 102 collects data at discrete logging points in the wellbore 104. For example, the logging tool 102 can move upward or downward incrementally to each logging point at a series of depths in the wellbore 104. At each logging point, instruments in the logging tool 102 perform measurements on the subterranean region 120. The measurement data can be communicated to the computing subsystem 110 for storage, processing, and analysis. Such data may be gathered and analyzed during drilling operations (e.g., during logging while drilling (LWD) operations), during wireline logging operations, or during other types of activities.

The computing subsystem 110 can receive and analyze the measurement data from the logging tool 102 to detect properties of various subsurface layers 122. For example, the computing subsystem 110 can identify the density, material content, or other properties of the subsurface layers 122 based on the measurements acquired by the logging tool 102 in the wellbore 104.

Logging system 108 can employ one or more subterranean logging modalities in order to obtain measurements and other logging data corresponding to the subterranean region 120. For instance, example logging systems 108 can perform nuclear magnetic resonance logging, density logging, neutron logging, acoustic logging, resistivity logging, spontaneous potential logging, dielectric logging, geochemical (i.e., elemental concentration) logging, gamma ray logging, natural gamma ray spectroscopy logging, as well logging using other types of logging modalities. Logging system 108 can be used to obtain various types of information corresponding to the subterranean region 120. For instance, example logging systems 108 can obtain information that can be used to determine various physical properties of the formation by solving one or more inverse problems. These physical properties can include, for example, the porosity, density, resistivity, volumetric, radioactivity, and other properties of the subterranean region 120.

Inverse problems encountered in well logging and geophysical applications may involve predicting the physical properties of some underlying system given a set of measurements (e.g., information obtained by one of more logging tools 108). In some implementations, an inverse problem may involve making a prediction based on a model. In some implementations, a model can be deterministic (i.e., a model in which every set of variable sets is uniquely determined by parameters in the model and by sets of previous states of these variables). In some implementations, a model can be probabilistic (i.e., a model in which randomness is present, and variable states are not described by unique values, but rather by stochastic distributions). In some implementations, models can include both deterministic and probabilistic characteristics.

Models can be used to solve the inverse problem of predicting the volumes various subterranean formations based on measurements obtained using a logging tool. For example, in some implementations, a model can include theoretical responses for a logging tool. These theoretical responses can be constructed using tool response equations that are functions of fluid and mineral volumes and their corresponding tool response parameters. After a model has been constructed, a mathematical solver can then be used to derive the solution for the formation volumes corresponding to the smallest differences between the theoretical tool responses of the model.

In order to improve the robustness of the model, information obtained by a logging tool can be integrated with information obtained from other sources (e.g., information obtained using other logging tools using other logging modalities). By integrating information from multiple logging modalities, the resulting model can be more robust against modality-dependent bias, and can more accurately predict representation of the subterranean region.

In an example, porosity measurements obtained using NMR logging tools can be integrated with information obtained from other tools in order to derive a model for formation fluid and mineral volume for a subterranean region. NMR total porosity measurements often respond to formation fluids in the near wellbore region, and can thus sense mixtures of water and hydrocarbons that influence porosity measurements made by other tools, such as neutron logging tools, density logging tools, and acoustic logging tools. Further, though resistivity tools are often not thought of as porosity measurements, resistivity measurements can often be directly linked to porosity and water/hydrocarbon volume content through water saturation calculations. Thus, NMR porosity measurements can be integrated with measurements obtained using other modalities such as neutron logging tools, density logging tools, acoustic logging, and resistivity logging, in order to obtain a robust model for predicting the porosity and volume of a subterranean region.

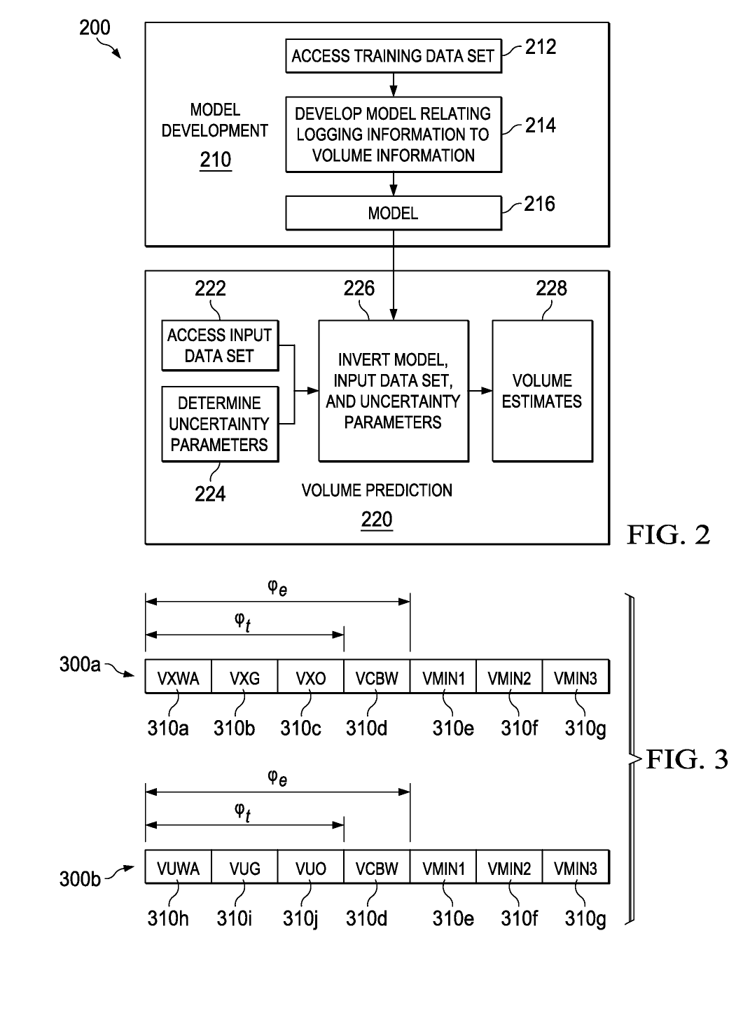

An example process 200 for predicting the fluid and mineral volumes of a subterranean formation is shown in FIG. 2. The example process 200 includes a model development sub-process 210 and volume prediction sub-process 220. The model development sub-process 210 can be used to develop a model based on a database of NMR logging information, logging information obtained with other logging modalities, and known information regarding the fluid and mineral volumes of one or more subterranean formations. The volume prediction sub-process 220 can be used to predict fluid and mineral volumes of an unknown subterranean formation based on NMR logging information and other logging information obtained from the unknown subterranean formation, and the developed model. The process 200 can include additional or different sub-processes or other operations, and the operations can be configured as shown or in another manner.

The example model development sub-process 210 includes accessing a data set (i.e., a “training” data set) (212). This training data set can include NMR logging information, logging information obtained with other logging modalities, and known information regarding the fluid and mineral volumes of one or more subterranean formations. This training data set can be used to train a model that relates the logging information to fluid and mineral volumes of the subterranean formation (214), which results in a model that predicts fluid and mineral volumes of a subterranean formation based on input logging information (216).

The example volume prediction sub-process 220 includes obtaining a data set (i.e., an “input” data set) (222). This input data set can include of NMR logging information and other logging information obtained from the unknown subterranean formation. In addition, uncertainty parameters corresponding to each measurement of the input data set can also be obtained (224). The input data set and uncertainty parameters are used as inputs in the model identified during model development, and are inverted in order to estimate volume information regarding the unknown subterranean formation (226), resulting in one or more volume estimates (228).

Data sets used for model training and prediction can be obtained in various ways. Data sets include can include NMR logging information, logging information obtained with other logging modalities, and known information regarding the fluid and mineral volumes of one or more subterranean formations. This information can be obtained in various ways. For instance, logging information can be obtained using one or more appropriate logging systems, such as a logging system 108. As an example, NMR logging systems, density logging systems, neutron logging systems, acoustic logging systems, resistivity logging systems, spontaneous potential logging systems, dielectric logging systems, geochemical (e.g., elemental concentration) logging systems, gamma ray logging systems, natural gamma ray spectroscopy logging systems, and other types of logging systems can be used to acquire measurements regarding one or more subterranean regions. These measurements can be collected according to techniques well known in the industry. Each of these measurements can be obtained either in situ (e.g., by performing logging operations on subterranean region) or ex situ (e.g., by performing logging operations on a sample that has been removed from a subterranean region). In some implementations, each of the measurements can be obtained simultaneously. For example, in some implementations, one or more tools are lowered into a borehole, and each is used to simultaneously acquire information regarding the subterranean region. In some implementations, each of the measurements can be obtained sequentially. For example, in some implementations, one or more tools are lowered into a borehole sequentially, and each is used to separately acquire information regarding the subterranean region.

In addition, known information regarding the fluid and mineral volumes of the one or more subterranean formations can be obtained in various ways. For instance, in some implementations, information regarding the fluid and mineral volumes can be obtained by removing a sample from a subterranean region, and determining the fluid and mineral volume of the subterranean formation using an appropriate ex situ measurement technique. Example of measurement techniques include laboratory analysis of core material or drill cuttings for mineralogy, porosity, grain density, elemental concentrations, and so forth. Likewise, produced fluid samples can be analyzed to provide information about the types of fluids present in the reservoir and their corresponding properties.

Data sets can be utilized immediately, or can be stored for future use. For instance, in some implementations, if process 200 is being conducted on logging system 108, data sets can be stored on the computing subsystem 110 or stored on a storage facility that is in communication with computing subsystem 110, such that the computer subsystem 110 can access the data sets when desired. In some implementations, if process 200 is being conducted on a system external to logging system 108, data sets can be stored on a storage device or facility that is in communication with the external system, such that the external system can access the data sets when desired.

One or more training data sets can be used to develop a model that relates the logging information to fluid and mineral volumes of the subterranean formation. Models can be developed in various ways. For example, in some implementations, theoretical responses for a logging tool can be constructed using tool response equations that are functions of fluid and mineral volumes and their corresponding tool response parameters.

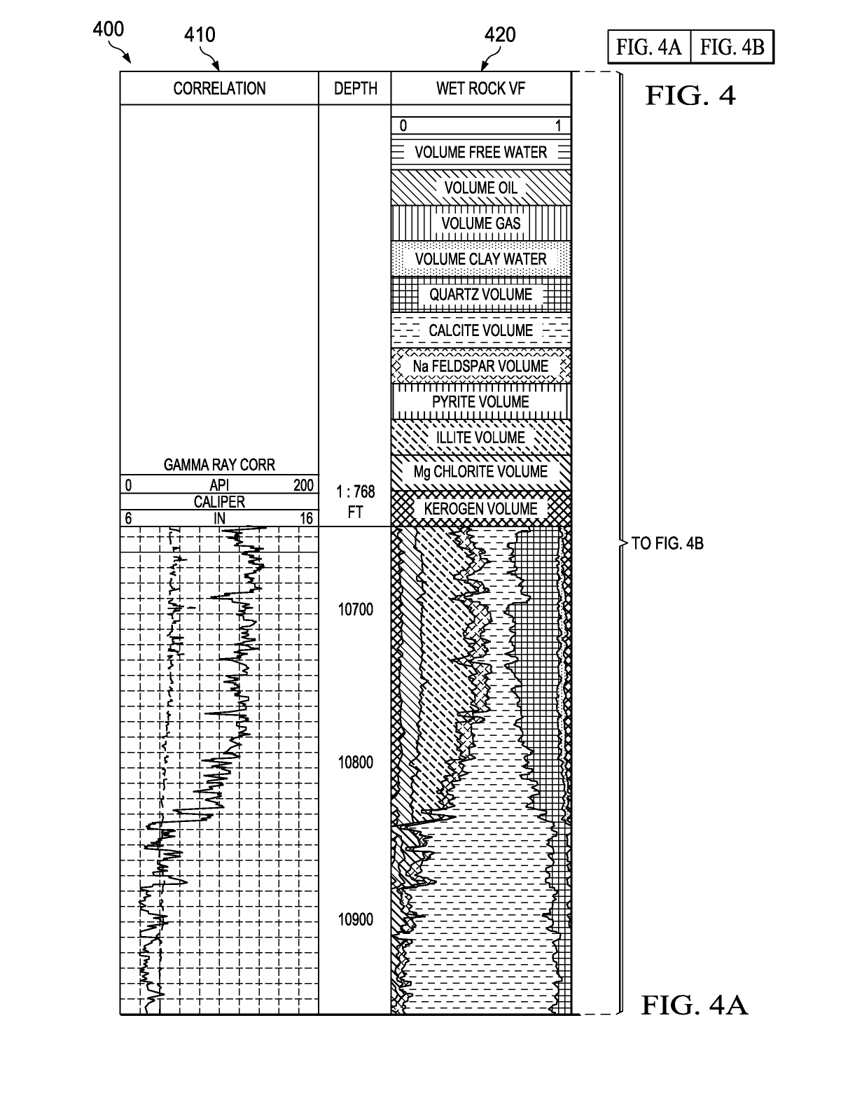

In some implementations, models can be developed based on an idealized representation to the physical system. For instance, referring to FIG. 3, an example subterranean region 120 can be volumetrically represented as one or more reservoirs 300. For example, the “invaded zone” of a subterranean region 120 (i.e., a volume of the subterranean region close to a wall of a borehole, in which some or all of the movable fluids have been displaced by mud filtrate) can be represented as a reservoir 300a, while an “undisturbed zone” of a subterranean region 120 (i.e., a volume of the subterranean region in which the moveable fluids have not been displaced by mud filtrate) can be represented as a reservoir 300b. Each reservoir 300a-b can include one or more independent volumes of free water (i.e., non-clay-bound water), gas, and oil. In some cases, both reservoirs 300a-b can share the same total volume of clay-bound water and mineral volumes and these constituents can be constant within the region investigated by a logging instrument. For instance, invaded zone reservoir 300a can include volumes of free water 310a (VXWA), gas 310b (VXG), and oil 310c (VXO), a total volume of clay-bound water 310d (VCBW), and mineral volumes 310e-g (VMIN1-3). Likewise undisturbed zone reservoir 300b can include volumes of free water 310h (VUWA), gas 310i (VUG), and oil 310j (VUO), a total volume of clay-bound water 310d (VCBW), and mineral volumes 310e-g (VMIN1-3).

In some implementations, mineral volumes refer to individual dry mineral volumes for clay minerals less their respective clay-bound water volumes, which are included in the total clay-bound water volume. Thus mineral volumes 310e-g can represent generic solid material. Further, clay minerals and other sheet-silicate minerals can be represented by a non-zero wet clay porosity (WCLP) response parameter corresponding to the fractional volume of clay-bound water associated with the wet clay. Thus, the total clay bound water volume (VCBW) among the modeled minerals can be expressed as:

$$VCBW = {\sum }_{i} \frac{{WCLP}_{i}}{1 - {WCLP}_{i}} {VMIN}_{i} ,$$

and the total volume of wet clay is the sum of VCBW and the sum of mineral volumes whose WCLP response parameters are greater than zero. Thus, VCBW can be an implicit formation volume when solving for minerals with non-zero WCLP response parameters. Further, effective porosity, φₑ, can be defined as the sum of free water, gas, and oil volumes, and total porosity, φₜ, can be defined as the sum of φₑ and VCBW.

While volumes 310a-j are used as examples, a subterranean region can be volumetrically represented in a manner that includes different independent volumes (e.g., volumes of other types of fluids and/or minerals), or different numbers of independent volumes (e.g., a fewer or greater number of independent volumes). Accordingly, the reservoirs 300a-b are used merely as an example representations of a physical system. For example, a model can be developed for a data set that includes measurements obtained using NMR logging, photoelectric absorption logging, density logging, and photoelectric logging in order to solve for the volume of free water (VXGA), gas (VXG), quartz (VQTZ), and illite (VILL) in an invaded zone. The theoretical density response ρ_{bth} for this example model can be expressed as:

$${ρ}_{bth} = {ρ}_{mf} \times VXWA + {ρ}_{g} \times VXG + {ρ}_{quartz} \times VQTZ + ( {ρ}_{illite} + \frac{{ρ}_{cbw} \times {WCLP}_{illite}}{1 - {WCLP}_{illite}} ) \times VILL ,$$

where ρ_{mf} is the mud filtrate density, ρ_{g} is the density of gas, ρ_{quartz} represents the density of quartz, ρᵢₗₗᵢₜₑ is the density of dry illite, ρ_{cbw} is the density of clay-bound water, and WCLPᵢₗₗᵢₜₑ is the wet clay porosity of illite.

A similar linear construction can be made to express the theoretical photoelectric response Uₜₕ, where Uₜₕ can be expressed as:

$${U}_{th} = {U}_{mf} \times VXWA + {U}_{g} \times VXG + {U}_{quartz} \times VQTZ + ( {U}_{illite} + \frac{{U}_{cbw} \times {WCLP}_{illite}}{1 - {WCLP}_{illite}} ) \times VILL ,$$

where U_{mf}, U_{g}, U_{quartz}, Uᵢₗₗᵢₜₑ, and U_{cbw} are the mud filtrate, gas, quartz, illite, and clay-bound water photoelectric response parameters, respectively.

Because NMR porosity logging tools sample the near wellbore region, the theoretical NMR porosity response can be constructed by using terms involving the invaded zone water, gas, and clay-bound water. In this example, the theoretical NMR total porosity response, φ_{NMRth} can be expressed as:

$${φ}_{NMRth} = {HI}_{mf} \times ( 1 - {e}^{- {T}_{w} / {T}_{1 mf}} ) \times VXWA + {HI}_{g} \times ( 1 - {e}^{- {T}_{w} / {T}_{1} g} ) \times VXG + \frac{{HI}_{cbw} \times {WCLP}_{illite}}{1 - {WCLP}_{illite}} \times VILL ,$$

where HI_{mf}, HI_{g}, and HI_{cbw} are the hydrogen indices of mud filtrate, gas, and clay-bound water.

In some implementations, it is possible that some fraction of the invaded zone free water and gas may not be fully polarized in the measured log response. To compensate for this, the theoretical NMR response can include corrections for under-polarization of these fluids, where T_{1mf} and T_{1g} represent longitudinal relaxation times for mud filtrate and gas, and T_{w} is the polarization recovery time used to acquire the measured NMR total porosity log. In this example, it can be assumed that hydrogen protons in clay-bound water will be fully polarized in any practical NMR total porosity measurement. Therefore, in this example, no under-polarization coefficient is included in the theoretical NMR total porosity response equation for clay-bound water.

In some implementations, the potassium elemental weight fraction log can be insensitive to formation fluids, as these fluids may not contain potassium. The elemental weight fraction theoretical response equation can be cast in terms of elemental density so that:

ρₖ=WK_{quartz}×ρ_{quartz}×VQTZ+WKᵢₗₗᵢₜₑ×ρᵢₗₗᵢₜₑ×VILL,

where ρₖ represents the theoretical density of potassium in the formation, WK_{quartz} is the weight fraction of potassium in quartz, and WKᵢₗₗᵢₜₑ represents the weight fraction of potassium in dry illite.

These theoretical response equations can be developed in various ways. For instance, in some implementations, theoretical response equations can be determined by determining a correlation between one or more training data sets and known information regarding the fluid and mineral volumes of the one or more subterranean formations. As an example, the theoretical density response equation ρ_{bth} can be determined by determining values for coefficients ρ_{mf}, ρ_{g}, ρ_{quartz}, ρᵢₗₗᵢₜₑ, ρ_{cbw}. In some implementations, these coefficient values can be determined deterministically, for example by finding a correlation between in situ density logging information obtained from a subterranean formation of known composition, ex situ density logging information obtained from samples or standards in an external setting, or a combination of information obtained in situ and ex situ. Likewise, theoretical response equations can be determined for other logging modalities by determining correlations between training data and known information regarding fluid and mineral volumes in the similar manner.

In this example, the four example theoretical response equations above can be combined into a model that includes a system of simultaneous equations involving the four desired formation volumes. This developed model can be used to probabilistically estimate volume information regarding an unknown subterranean formation, based on an input data set of measurements of the unknown subterranean region.

For example, an estimate can be determined by inverting the developed model, an input data set of measurements of the unknown subterranean formation, and uncertainty parameters corresponding to each measurement of the input data set. In some implementations, this inversion can be achieved by minimizing a cost function, for instance an objective or incoherence function:

$$INCO = \frac{{( {ρ}_{bth} - RHOB )}^{2}}{{σ}_{RHOB}^{2}} + \frac{{( {U}_{th} - U )}^{2}}{{σ}_{U}^{2}} + \frac{( {φ}_{NMRth} - MPHITA )}{{σ}_{MPHITA}^{2}} + \frac{( {ρ}_{K} - {ρ}_{bth} \times WWK )}{{σ}_{WWK}^{2}} ,$$

where RHOB, U, MPHITA, and WWK are measurements of the input data set, and σ_{RHOB}², σ_{U}², σ_{MPHITA}², and σ_{WWK}² are uncertainty parameters that represent uncertainties for the respective RHOB, U, MPHITA, and WWK measurements.

For the above example incoherence function, the function's minimum occurs where its derivatives with respect to VXGA, VXG, VOTZ and VILL are equal to zero. The solution that satisfies this condition can be found using various techniques, for example by invoking a suitable numerical solver (e.g., the Stanford University NPSOL solver, or other such numerical solver). When this incoherence function is minimized, the values for VXGA, VXG, VOTZ and VILL represent the estimates for the volume of free water (VXGA), gas (VXG), quartz (VQTZ), and illite (VILL) in unknown subterranean region. Hence, this solution represents a probabilistic error minimization interpretation of the model's theoretical response equations, the input data set, and the uncertainty parameters.

The input data set used in volume prediction includes measurements of the unknown subterranean region being logged. These measurements can be obtained in various ways, for instance, using one or more of the techniques previously described. In the above example, RHOB is the input formation density log measurement, U is the input photoelectric absorption log measurement, MPHITA is the input NMR total porosity log measurement, and WWK is the input potassium weight fraction log measurement in the fluid-wet formation.

In the above example, the variables σ_{RHOB}², σ_{U}², σ_{MPHITA}², and σ_{WWK}² are uncertainty parameters that represent uncertainties for the respective RHOB, U, MPHITA, and WWK measured logs. As such, their magnitudes quantify the weight each measurement has in determining the solution volumes. These uncertainty parameters can be determined using various techniques. For instance, in some implementations, the uncertainty parameters characterize signal noise corresponding to each measurement, and can be used to compensate for measurements that are noisy. In an example, a measurement that is noisy can be compensated by weighting its corresponding term in the incoherence function such that the term has a reduced influence on the solution (e.g., by increasing the value of uncertainty parameter). In another example, a measurement that is not noisy can be compensated by weighting its corresponding term in the incoherence function such that the term has an increased influence on the solution (e.g., by decreased the value of uncertainty parameter). In some implementations, the uncertainty parameters can depend directly or indirectly on quantitative factors, for example a measurement's calculated or expected signal-to-noise ratio (SNR). In some implementations, the uncertainty parameters can based on subjective or qualitative factors. In some implementations, the uncertainty parameters can depend on both quantitative and qualitative factors.

In some implementations, the uncertainty parameters are determined empirically. For instance, uncertainty parameters can be determined based on known information regarding the input data set of measurements, the subterranean region being logged, and/or the logging modalities being used to log the subterranean region. As an example, based on previous experience with a similar subterranean region, a particular combination of uncertainty parameters can be selected based on prior success using that combination. In some implementations, the uncertainty parameters can be selected as a set from among a plurality of pre-determined sets of uncertainty parameters. As an example, multiple sets of uncertainty parameters can be stored based on prior success under various conditions, and one of the sets of uncertainty parameters can be selected that best suits the current conditions. This selection can occur manually (e.g., manually selected by an operator), automatically (e.g., automatically selected by a processing system based on condition information known to the processing system), or a combination (e.g., automatically selected based on condition information manually inputted by an operator). In some implementations, the uncertainty parameters can be selected such that the measurements of the input data set are weighted equally. In some implementations, the uncertainty parameters can be selected such that the measurements of the input data set are not weighted equally.

In some implementations, the probabilistic error minimization technique amounts to a weighted least-squares fitting of the theoretical response equations to the measured logs, where the goal of the error minimization technique is to obtain the most likely solution for a given set of log responses, response parameters and selection of unknown volumes.

While the above example described the use of NMR logging, photoelectric absorption logging, density logging, and photoelectric logging in order to solve for the volume of free water (VXGA), gas (VXG), quartz (VQTZ), and illite (VILL) in an invaded zone, other combinations of logging modalities and/or unknown volumes can also be used. For example, in some implementations, a model can integrate data sets obtained using nuclear resonance logging and at least three two of the following: density logging, neutron logging, acoustic logging, resistivity logging, spontaneous potential logging, dielectric logging, geochemical (elemental concentration) logging, gamma ray logging, and natural gamma ray spectroscopy logging. In another example, in some implementations, a model can be used to solve for various volumes of a subterranean region, for example, free water, gas, oil, quartz, illite, calcite, pyrite, magnesium chlorite, and kerogen. Accordingly, in some implementations, a probabilistic model can be constructed to solve for any appropriate combination of pore fluids and a collection of rock minerals that reasonably describes the subterranean formation in which a plurality of logging measurements is equal to or greater than the number of unknown volumes less one.

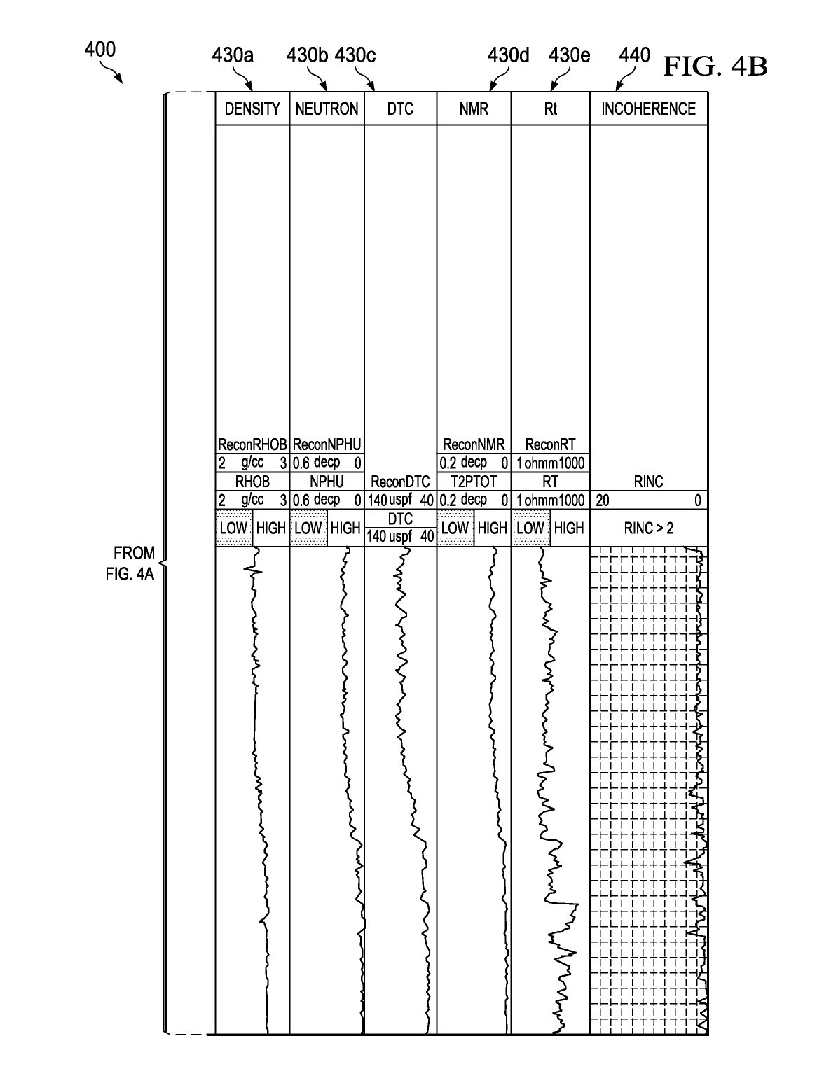

In an example, FIGS. 4A-B show an example 400 of formation mineral and fluid volume results obtained by using several logs in combination with a NMR total porosity log. Plot 410 shows caliper and gamma ray logs for correlation purposes. Plot 420 shows the breakdown of formation fluid and mineral volumes from the probabilistic error minimization interpretation. Plots 410a-e show overlays of some of the reconstructed logs and measured logs used in this interpretation. Plot 440 shows a normalized or, reduced incoherence value derived from the incoherence function when the probabilistic error minimization solution was found.

In some examples, one or more of the above implementations can be used when an over-determined system of simultaneous response equations exists (i.e., where there are more response equations than the number of unknown volumes). In other examples, by adding one or more constraint equations, one or more of the above implementations can still be used when an under-determined system exists (i.e., where the number of response equations is fewer than the number of unknown volumes).

As an example, in some implementations, a constraint equation can be used that restricts the sum of unknown volumes to be equal to unity. An example constraint can be expressed as:

$$1 \leq VXWA + VXG + VQTZ + ( 1 + \frac{{WCLP}_{illite}}{1 - {WCLIP}_{illite}} ) \times VILL \leq 1$$

This constraint effectively becomes an additional response equation, and can be used to produce a well-determined or over-determined system, even if the system of simultaneous response equations is under-determined.

Additional inequality constraints can be devised to further restrict the solution space available to the numerical solver. For example, in some implementations, the volumes for one or more of the fluid and mineral constituents may be known to be within a certain range. For instance, based on prior knowledge, it may be known that the volume of free water is known to be within a particular range (e.g., between 5-15% of the total volume), the volume of gas is known to be within a particular range (e.g., between 10-20% of the total volume), and so forth. These known ranges can be expressed as constraint equations to further regularize a system.

In the above examples, the theoretical response equation for each of the logging modalities takes on a linear form. The theoretical response equations of some logging modalities, such as neutron porosity, conductivity, and acoustic are non-linear. Accordingly, in some implementations, both linear and non-linear tool response equations can be used in the model.

In some implementations, it possible to integrate the NMR total porosity response alongside other available logs to determine a detailed breakdown of formation fluids and mineralogy. For instance, NMR porosity logging can often provide a very good estimate of porosity without knowledge of the formation mineralogy when hydrocarbons are not present. NMR total porosity measurements can be influenced by the presence of hydrocarbons, as are many other conventional porosity logs. In some implementations, additional information may be required to compensate for the influences of hydrocarbons, especially light hydrocarbons, so that an accurate portrayal of porosity is obtained. This compensation can be achieved by combining two or more porosity sensitive logs in a manner that accounts for the individual contributions of water and hydrocarbon. Accordingly, so-called “sourceless” porosity determinations can be obtained in hydrocarbon-bearing formations by combining NMR total porosity logs with other near well bore sensing logs obtained with tools that do not use of a chemical radioactive source to perform their measurement. In some implementations, “sourceless” porosity combinations could include passive natural gamma ray, acoustic, shallow-reading resistivity, dielectric, and spontaneous potential logs as may be available with NMR total porosity measurements.

One or more of the above described implementations may provide certain benefits. For example, some implementations can be used to integrate measurements obtained with NMR logging systems with measurements obtained with logging systems of other logging modalities in order to provide robust multi-tool interpretation of each system's measurements. Some implementations can be used with various combinations of logging modalities, and are not limited to specific combinations of logging modalities.

In some implementations, measurements obtained with NMR logging systems may be used without relying on quantities derived from interpretations placed on magnetic resonance relaxation distributions, which may not be appropriate or well known, in a given reservoir. As an example, some implementations may be used to overcome the potential misinterpretation fast NMR relaxation times in carbonate or turbidite environments that are not related to clay-bound water. In implementations that use the total porosity response of the NMR tool, the interpretation is not hindered by overlapping relaxation times of irreducible water and hydrocarbons. In some implementations, the influences of pore fluid hydrogen indices and potential under-polarization of hydrocarbons are fully accounted for in the tool response equation so that the NMR total porosity response is compatible with other porosity measurements. Thus, the NMR tool response can be reliably used with other tools in arriving at the final fluid and mineral volumes determination.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A computer system may include a single computing device, or multiple computers that operate in proximity or generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). A relationship of client and server may arise by virtue of computer programs running on the respective computers and having a client-server relationship to each other.

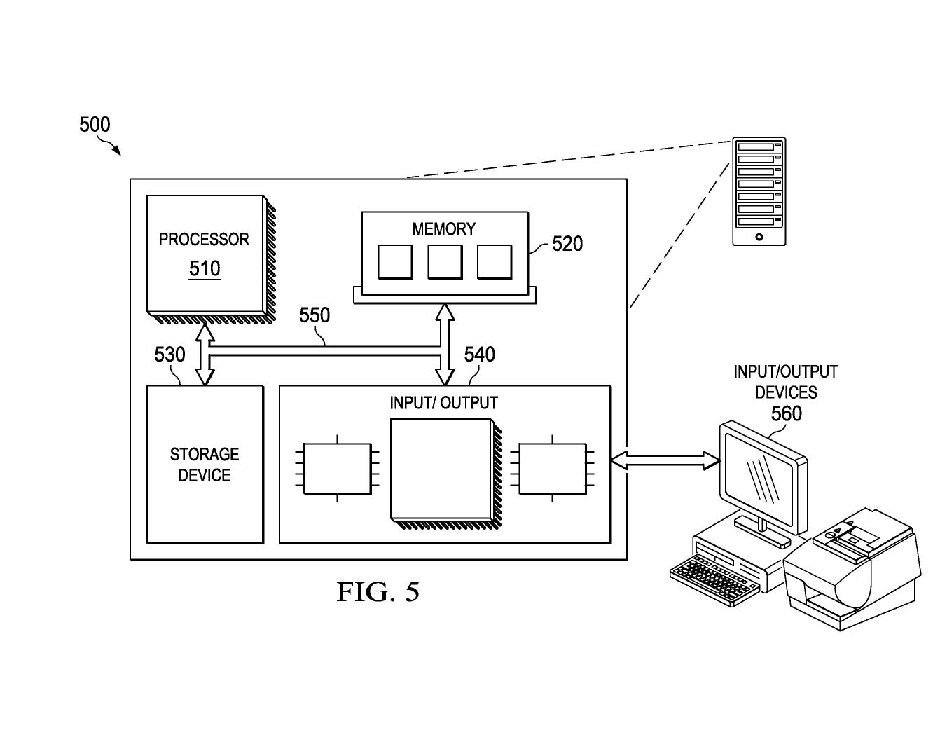

FIG. 5 shows an example computer system 500. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. In some implementations, the input/output device can include driver devices configured to receive input data and send output data to other input/output devices, e.g., keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

Various aspects of the invention may be summarized as follows.

In general, in an aspect, a method for estimating properties of a subterranean region includes accessing a first data set that includes measurements of a first subterranean region acquired by each of at least three different subterranean logging modalities. The method also includes determining, from the first data set, a model relating logging information to a physical property of the first subterranean region using an electronic processing module, where the model is based on correlations between the measurements of the first subterranean region and at least one physical property of the first subterranean region. The method also includes accessing a second data set that includes measurements of a second subterranean region acquired by nuclear magnetic resonance logging and each of the other subterranean logging modalities. The method also includes estimating a value for a parameter characterizing at least one physical property of the second subterranean region using the electronic processing module. The estimated value is based on an inversion of the second data set, the model, and uncertainty parameters corresponding to each measurement of the second data set, and the uncertainty parameters characterize signal noise corresponding to each measurement of the second data set.

Implementations of this aspect may include one or more of the following features:

The subterranean logging modalities can include nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

Each physical property can correspond to a volume of a material of the corresponding subterranean region. The material can be free water, free gas, free oil, clay-bound water, or a mineral.

Estimating at least one physical property can include using a cost function to weight each measurement of the second data set of measurements by the corresponding uncertainty parameter. The uncertainty parameters can be selected such that each measurement of the second data set is weighted equally. The uncertainty parameters can be selected such that the measurements of the second data set are not weighted equally. The uncertainty parameters can be selected as a set from among a plurality of pre-determined sets of uncertainty parameters.

Estimating at least one physical property can be further based on a constraint equation, where the constraint equation restricts each of at least one physical property to a corresponding range of values. The method can further include determining each range of values based on pre-determined knowledge of the second subterranean region. Each physical property can correspond to a volume of a material of the corresponding subterranean region, and where the constraint equation restricts a sum of the volumes to be a pre-determined value. The pre-determined value can be one.

In general, in another aspect, a system includes a computing system operable to receive a first data set a second data set, the first data set including measurements of a first subterranean region acquired by each of at least three different subterranean logging modalities, and the second data set including measurements of a second subterranean region acquired by each of the different subterranean logging modalities. The computing system includes a data processing apparatus operable to perform operations that include determining a model, where the model is based on correlations between the measurements of the first data set and a physical property of the first subterranean region, and estimating at least one physical property of the second subterranean region, where the estimated physical property is based on an inversion of the second data set, the model, and uncertainty parameters corresponding to each measurement of the second data set, and the uncertainty parameters characterize signal noise corresponding to each measurement of the second data set.

Implementations of this aspect may include one or more of the following features:

The subterranean logging modalities can include nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

Each physical property can correspond to a volume of a material of the corresponding subterranean region. The material can be free water, free gas, free oil, clay-bound water, or a mineral.

The data processing apparatus can be operable to estimate at least one physical property by using a cost function to weight each measurement of the second data set of measurements by the corresponding uncertainty parameter. The data processing apparatus can be operable to select uncertainty parameters such that each measurement of the second data set is weighted equally. The data processing apparatus can be operable to select uncertainty parameters uncertainty parameters such that the measurements of the second data set are not weighted equally. The data processing apparatus can be operable to select uncertainty parameters as a set from among a plurality of pre-determined sets of uncertainty parameters.

The data processing apparatus can be operable to estimate at least one physical property further based on a constraint equation, where the constraint equation restricts each of at least one physical property to a corresponding range of values. The data processing apparatus can be operable to determine each range of values based on pre-determined knowledge of the second subterranean region. Each physical property can correspond to a volume of a material of the corresponding subterranean region, and the constraint equation can restrict a sum of the volumes to be a pre-determined value. The pre-determined value can be one.

In general, in another aspect, a non-transitory computer readable medium storing instructions that are operable when executed by data processing apparatus to perform operations includes accessing a first data set that includes measurements of a first subterranean region acquired by each of at least three different subterranean logging modalities. The operations also include determining, from the first data set, a model relating logging information to a physical property of the first subterranean region using an electronic processing module, where the model is based on correlations between the measurements of the first subterranean region and at least one physical property of the first subterranean region. The operations also include accessing a second data set that includes measurements of a second subterranean region acquired by nuclear magnetic resonance logging and each of the other subterranean logging modalities. The operations also include estimating a value for a parameter characterizing at least one physical property of the second subterranean region using the electronic processing module. The estimated value is based on an inversion of the second data set, the model, and uncertainty parameters corresponding to each measurement of the second data set, and the uncertainty parameters characterize signal noise corresponding to each measurement of the second data set.

Implementations of this aspect may include one or more of the following features:

The subterranean logging modalities can include nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

Each physical property can correspond to a volume of a material of the corresponding subterranean region. The material can be free water, free gas, free oil, clay-bound water, or a mineral. Estimating at least one physical property can include using a cost function to weight each measurement of the second data set of measurements by the corresponding uncertainty parameter. The uncertainty parameters can be selected such that each measurement of the second data set is weighted equally. The uncertainty parameters can be selected such that the measurements of the second data set are not weighted equally. The uncertainty parameters can be selected as a set from among a plurality of pre-determined sets of uncertainty parameters.

Estimating at least one physical property can be further based on a constraint equation, where the constraint equation restricts each of at least one physical property to a corresponding range of values. The operations can further include determining each range of values based on pre-determined knowledge of the second subterranean region.

Each physical property can correspond to a volume of a material of the corresponding subterranean region. The constraint equation can restrict a sum of the volumes to be a pre-determined value. The pre-determined value can be one.

A number of embodiments have been described. Nevertheless, it will be understood that various modifications may be made without departing from the spirit and scope of the invention. Accordingly, other embodiments are within the scope of the following claims.

1. A method for estimating properties of a subterranean region, the method comprising:
accessing a first data set comprising measurements of a first subterranean region acquired by each of at least three different subterranean logging modalities, where at least one of the subterranean logging modalities is nuclear magnetic resonance logging;
determining, from the first data set, a model relating logging information to a physical property of the first subterranean region using an electronic processing module, wherein the model is based on correlations between the measurements of the first subterranean region and at least one physical property of the first subterranean region;
accessing a second data set comprising measurements of a second subterranean region acquired by each of the different subterranean logging modalities; and
estimating a value for a parameter characterizing at least one physical property of the second subterranean region using the electronic processing module,
wherein the estimated value is based on an inversion of the second data set, the model, and uncertainty parameters corresponding to each measurement of the second data set, and
the uncertainty parameters characterize signal noise corresponding to each measurement of the second data set.

2. The method of claim 1, wherein the subterranean logging modalities comprise nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

3. The method of claim 1, wherein each physical property corresponds to a volume of a material of a corresponding subterranean region.

4. The method of claim 3, wherein the material is free water, free gas, free oil, clay-bound water, or a mineral.

5. The method of claim 3, wherein estimating at least one physical property comprises using a cost function to weight each measurement of the second data set of measurements by the corresponding uncertainty parameter.

6. The method of claim 5, wherein the uncertainty parameters are selected such that each measurement of the second data set is weighted equally.

7. The method of claim 5, wherein the uncertainty parameters are selected such that the measurements of the second data set are not weighted equally.

8. The method of claim 5, wherein the uncertainty parameters are selected as a set from among a plurality of pre-determined sets of uncertainty parameters.

9. The method of claim 1, wherein estimating at least one physical property is further based on a constraint equation, wherein the constraint equation restricts each of at least one physical property to a corresponding range of values.

10. The method of claim 9, further comprising determining each range of values based on pre-determined knowledge of the second subterranean region.

11. The method of claim 9, wherein each physical property corresponds to a volume of a material of a corresponding subterranean region, and wherein the constraint equation restricts a sum of the volumes to be a pre-determined value.

12. The method of claim 11, wherein the pre-determined value is one.

13. A system comprising:
a computing system operable to receive a first data set and a second data set, the first data set comprising measurements of a first subterranean region acquired by each of at least three different subterranean logging modalities, and the second data set comprising measurements of a second subterranean region acquired by each of the different subterranean logging modalities;
the computing system comprising a data processing apparatus operable to perform operations that include:
determining a model, wherein the model is based on correlations between the measurements of the first data set and a physical property of the first subterranean region; and
estimating at least one physical property of the second subterranean region,
wherein the estimated physical property is based on an inversion of the second data set, the model, and uncertainty parameters corresponding to each measurement of the second data set, and
the uncertainty parameters characterize signal noise corresponding to each measurement of the second data set.

14. The system of claim 13, wherein the subterranean logging modalities comprise nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

15. The system of claim 13, wherein each physical property corresponds to a volume of a material of a corresponding subterranean region.

16. The system of claim 15, wherein the material is free water, free gas, free oil, clay-bound water, or a mineral.

17. The system of claim 15, wherein data processing apparatus is operable to estimate at least one physical property by using a cost function to weight each measurement of the second data set of measurements by the corresponding uncertainty parameter.

18. The system of claim 17, wherein the data processing apparatus is operable to select uncertainty parameters such that each measurement of the second data set is weighted equally.

19. The system of claim 17, wherein the data processing apparatus is operable to select uncertainty parameters uncertainty parameters such that the measurements of the second data set are not weighted equally.

20. The system of claim 17, wherein the data processing apparatus is operable to select uncertainty parameters as a set from among a plurality of pre-determined sets of uncertainty parameters.

21. The system of claim 13, wherein the data processing apparatus is operable to estimate at least one physical property further based on a constraint equation, wherein the constraint equation restricts each of at least one physical property to a corresponding range of values.

22. The system of claim 21, wherein the data processing apparatus is operable to determine each range of values based on pre-determined knowledge of the second subterranean region.

23. The system of claim 21, wherein each physical property corresponds to a volume of a material of a corresponding subterranean region, and wherein the constraint equation restricts a sum of the volumes to be a pre-determined value.

24. The system of claim 23, wherein the pre-determined value is one.

25. A non-transitory computer readable medium storing instructions that are operable when executed by data processing apparatus to perform operations comprising:
accessing a first data set comprising measurements of a first subterranean region acquired by each of at least three different subterranean logging modalities, where at least one of the subterranean logging modalities is nuclear magnetic resonance logging;
determining, from the first data set, a model relating logging information to a physical property of the first subterranean region using an electronic processing module, wherein the model is based on correlations between the measurements of the first subterranean region and at least one physical property of the first subterranean region;
accessing a second data set comprising measurements of a second subterranean region acquired by each of the different subterranean logging modalities; and
estimating a value for a parameter characterizing at least one physical property of the second subterranean region using the electronic processing module,
wherein the estimated value is based on an inversion of the second data set, the model, and uncertainty parameters corresponding to each measurement of the second data set, and
the uncertainty parameters characterize signal noise corresponding to each measurement of the second data set.

26. The non-transitory computer readable medium of claim 25, wherein the subterranean logging modalities comprise nuclear resonance logging and at least two of the following: density logging, neutron logging, acoustic logging, resistivity logging, spontaneous potential logging, dielectric logging, geochemical logging, gamma ray logging, and natural gamma ray spectroscopy logging.

27. The non-transitory computer readable medium of claim 25, wherein each physical property corresponds to a volume of a material of a corresponding subterranean region.

28. The non-transitory computer readable medium of claim 27, wherein the material is free water, free gas, free oil, clay-bound water, or a mineral.

29. The non-transitory computer readable medium of claim 27, wherein estimating at least one physical property comprises using a cost function to weight each measurement of the second data set of measurements by the corresponding uncertainty parameter.

30. The non-transitory computer readable medium of claim 29, wherein the uncertainty parameters are selected such that each measurement of the second data set is weighted equally.

31. The non-transitory computer readable medium of claim 29, wherein the uncertainty parameters are selected such that the measurements of the second data set are not weighted equally.

32. The non-transitory computer readable medium of claim 30, wherein the uncertainty parameters are selected as a set from among a plurality of pre-determined sets of uncertainty parameters.

33. The non-transitory computer readable medium of claim 25, wherein estimating at least one physical property is further based on a constraint equation, wherein the constraint equation restricts each of at least one physical property to a corresponding range of values.

34. The non-transitory computer readable medium of claim 33, the operations further comprising determining each range of values based on pre-determined knowledge of the second subterranean region.

35. The non-transitory computer readable medium of claim 27, wherein each physical property corresponds to a volume of a material of a corresponding subterranean region, and wherein a constraint equation restricts a sum of the volumes to be a pre-determined value.

36. The non-transitory computer readable medium of claim 35, wherein the pre-determined value is one.
